(19) United States
(12) Patent Application Publication
(10) Pub. No.: US 2009/0174656 A1
(43) Pub. Date: Jul. 9, 2009

(54) ELECTRONIC IMAGE IDENTIFICATION AND ANIMATION SYSTEM

(75) Inventors: Chad Voss, Seattle, WA (US); Julio Sandoval, Lancaster, CA (US); George Foster, Placerville, CA (US); Elliot Rudell, Redondo Beach, CA (US)

Correspondence Address: IRELL & MANELLA LLP, 1800 AVENUE OF THE STARS, SUITE 900, LOS ANGELES, CA, 90067, US

(73) Assignee: Rudell Design LLC, Torrance, CA (US)

(21) Appl. No.: 12/350,059

(22) Filed: Jan. 7, 2009

Related U.S. Application Data
(60) Provisional application No. 61/010,319, filed on Jan. 7, 2008.

(51) Int. Cl. G06F 3/033; G06K 9/00

(52) U.S. Cl. 345/157; 382/100

(57) ABSTRACT

An electronic system that includes a working surface and a camera that can capture a plurality of images on the working surface. The system also includes a control station that is coupled to the camera and has a monitor that can display the captured images. The monitor displays a moving graphical image having a characteristic that is a function of a user input on the working surface. By way of example, the graphical image may be a character created from markings formed on the working surface by the user. The system can then “animate” the character by causing graphical character movement.

### CROSS-REFERENCE TO RELATED APPLICATIONS

This application claims priority to Application No. 61/010,319, filed on Jan. 7, 2008.

### BACKGROUND OF THE INVENTION

1. Field of the Invention

The present invention relates to a system that can be used to control and vary graphical images displayed by a monitor.

2. Prior Art

There have been products on the market that have utilized camera-input for image recognition and manipulation. The following are examples of such products.

Sony Corporation provided an electronic game under the name Eye of Judgment that identified a card placed on a play mat under a camera. Each card bears a unique line code that is identified in a stored library within the software of the system. There is no ability to customize or create any images that will actively affect the onscreen display, or the game outcome.

Radica Digi Makeover provided by Radica was a game that functionally, was a child's version of a product sold as Adobe Photoshop, that is housed within a portable play unit. The software allows the child to manipulate photographs captured by a camera—deleting areas, adding overlays of stored images, etc. There is no live identification of any captured or kid-manipulated images, and nothing in the product will allow a user to affect an onscreen activity by inputting colors, shapes, etc.

The product KidiArt Studio provided by VTech has a smart writing tablet for the user, and provides a digital camera above the tablet to take pictures of user-drawn images, or the user himself. The images are not live-identified, and there are no response to the composition or color of any captured image.

Manley provided a product under the name RipRoar Creation Station that is a video editing software product. The product edits live video, allowing the user to eliminate the background to create custom scenes. There are no working surface on which to draw or input custom elements. Additionally, there are no active response by the software to color variances, or identification or live manipulation of captured visual elements.

Marvel Ani-Movie by Jazzwares utilized captured images in a stop-action format. There are no provisions for creative manipulation and input, and there are no software response to, nor identification of, color differences in the captured images.

ManyCam's free downloadable software allows a user with any web cam to capture their own live-action image, add stored clip art to that image (such as a hat) and then speak to another person in a computer chat setting. The software analyzes the image and allows the clip art to move along with the image. The software did not identify color, and did not provide for graphical user input or artwork generation by the user. It is webcam software, only.

### BRIEF SUMMARY OF THE INVENTION

An electronic system that includes a working surface and a camera that can capture a plurality of images on the working surface. The system also includes a control station that is coupled to the camera and has a monitor that can display the images captured by the camera. The monitor displays a moving graphical image with a characteristic that is a function of a user input on the working surface that is captured by the camera.

### BRIEF DESCRIPTION OF THE DRAWINGS

FIG. 1 is an illustration of an electronic system;

FIG. 2 is an illustration showing an image displayed by a monitor;

FIG. 3 is a flowchart showing a use of the system;

FIG. 4 is an illustration of the image showing a graphical image;

FIG. 5 is an illustration similar to FIG. 4 showing the graphical image changing direction;

FIG. 6 is an illustration similar to FIG. 5 showing the graphical image changing direction;

FIG. 7 is a flowchart showing a different use of the system;

FIG. 8 is an illustration showing a template overlayed on a captured image of a working surface;

FIG. 9 is an illustration showing the creation of a graphical image;

FIG. 10 is an illustration showing a picture that can be captured and animated by the system;

FIG. 11 is an illustration showing a different use of the system;

FIG. 12 is an illustration similar to FIG. 11 showing the correct selection of letters;

FIG. 13 is an illustration of a user marking a track;

FIG. 14 is an illustration showing movements of toy vehicles that cause a corresponding movement of graphical images displayed on a monitor of the system.

### DETAILED DESCRIPTION

Disclosed is an electronic system that includes a working surface and a camera that can capture a plurality of images of the working surface. The system also includes a control station that is coupled to the camera and has a monitor that can display the captured images. By way of example, the control station can be a home computer with a digital monitor, or the control station can be part of an electronic home entertainment system, with digital inputs providing for image display on a television or digital monitor. The monitor displays a moving graphical image having a characteristic that is a function of a user input on the working surface. By way of example, the graphical image may be a character created from markings formed on the working surface by the user. The system can then “animate” the character by causing graphical character movement of the image displayed on the monitor. Images of the working surface include colored markings, pictures, objects, human appendages or anything in the field of view of the camera.

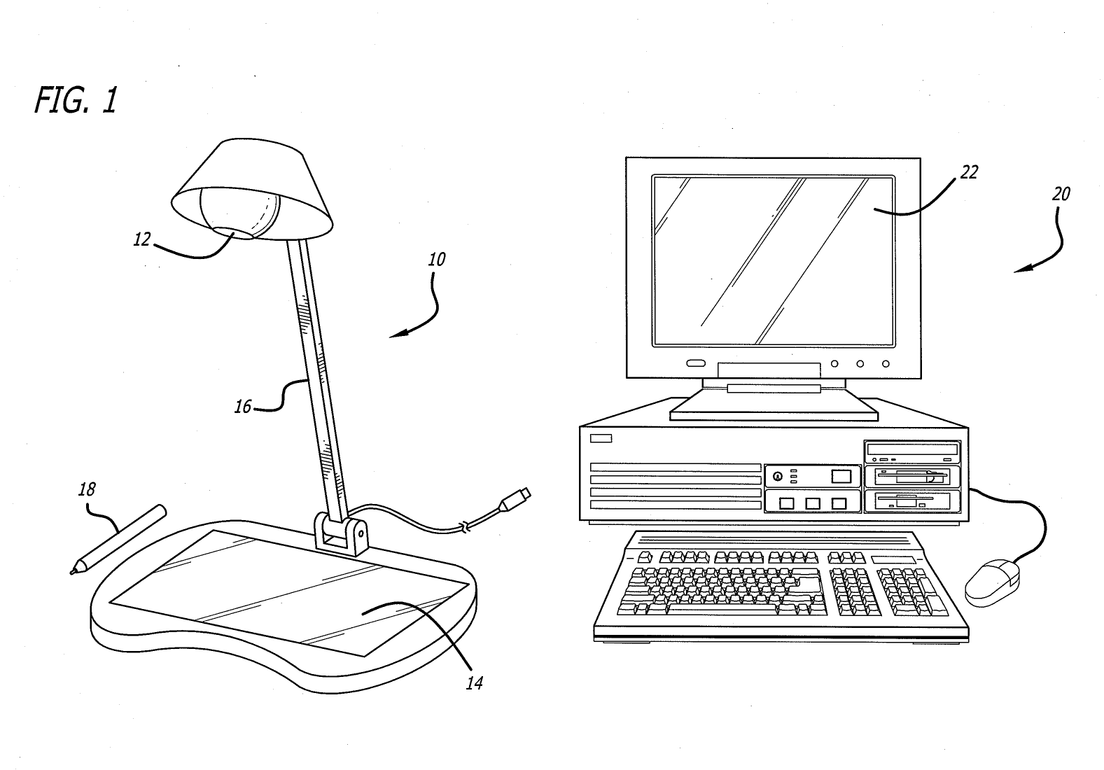

Referring to the drawings more particularly by reference numbers, FIG. 1 shows an embodiment of an electronic system 10. The system 10 includes a camera 12 that is supported above a working surface 14 by a linkage 16. The linkage 16 may include mechanical joints that allow the user to move the camera 12 relative to the working surface 14. The system 10 may include one or more writing instruments 18. By way of example, the writing instruments 18 may be markers that can leave markings on the working surface 14. The writing instruments 18 can leave markings of different colors. For example, the instruments may leave red, blue, green or black markings. The working surface 14 can be of a finish, material, etc. that allows the markings to be readily removed from the surface 14. For example, the working surface 14 may be constructed from an acrylic material. The camera 12 can capture images of the working surface 14, objects placed on the working surface, or anything within the camera field of view.

The camera 12 is coupled to a control station 20. By way of example, the control station 20 may be a personal computer and the camera 12 can be connected to the computer either through a USB port of the computer, wirelessly via Bluetooth, or other wireless technology. The control station 20 includes a monitor 22. The station may include one or more processors, memory, a storage device, I/O devices, etc., that are commonly found in personal computers.

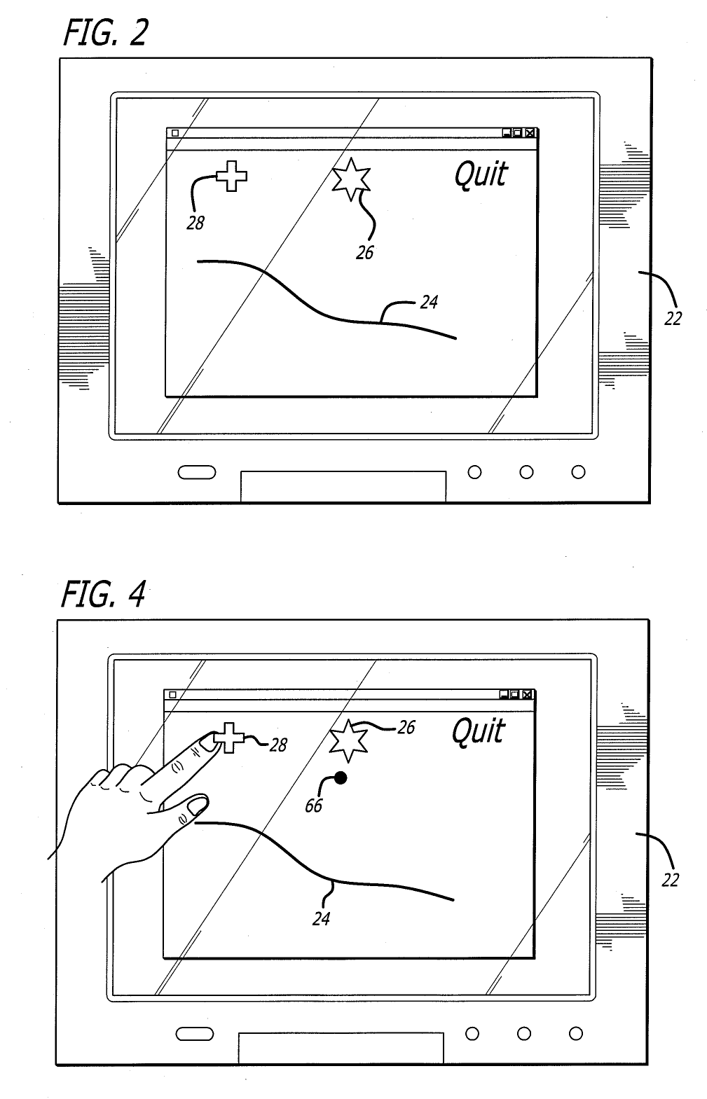

The monitor 22 can display images of the working surface 14. The images can be captured at a frequency so that the images appear as real time video images. As shown in FIG. 2, the user may create a marking 24 that is captured by the camera and displayed by the monitor 22. The station 20 can overlay a first graphical icon 26 and a second graphical icon 28 onto the video image of the working surface.

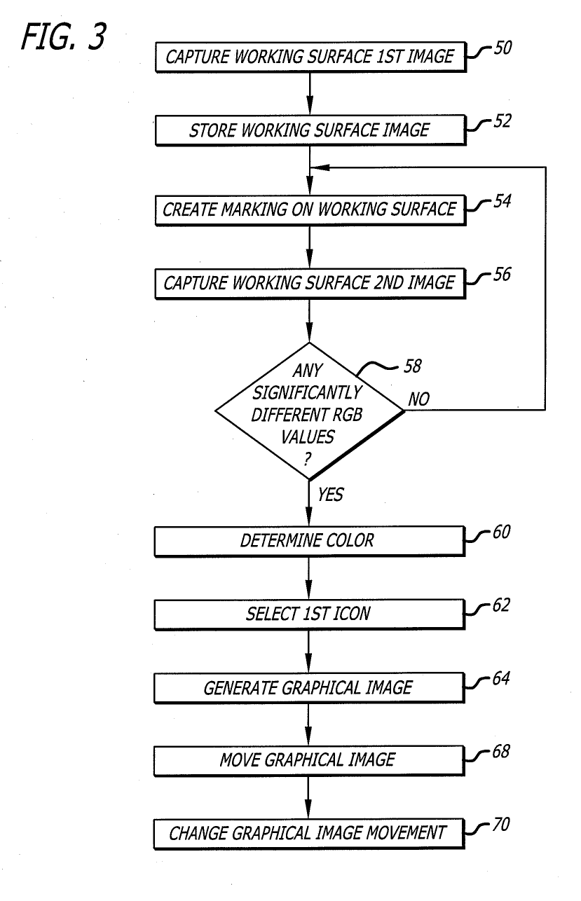

FIG. 3 shows a process for moving a graphical image in response to a user input that is captured by the camera 12. In step 50 the camera 12 captures an image of the working surface 14. The image is stored in memory of the control station 20 in step 52. By way of example, the image may be stored as a bitmap containing the red, blue and green (“RGB”) values of each pixel in an image. The user can create a marking 24 (as shown in FIG. 2) on the working surface 14 (as shown in FIG. 1) in step 54. In step 56 the camera captures a second image of the working surface with the marking. In decision block 58, the station compares the second image with the first image to determine whether any area of the second image has significantly different RGB values than the RGB values of the first image. If the second image does have significantly different RGB values then the station determines the color of the area of the working surface with the different RGB values in step 60. If the second image does not have significantly different RGB values, the process returns to step 54 and the process is repeated.

In step 62 the user provides an input to select the first icon 28 shown in FIG. 4. The input may be placing a finger in the view of the camera so that the user's finger coincides with the location of the first icon 28. The system can perform an image recognition process to determine when the finger intercepts with the location of the first icon 28. In step 64 selection of the first icon 28 causes the generation of a stored graphical image 66 that emerges from the second icon 26 as shown in FIG. 4. By way of example, the graphical image 66 may be a graphical dot. Referring to FIG. 3, in step 68 the graphical image 66 moves downward on the monitor. A characteristic of the graphical image movement may correspond to the color of the marking 24 generated by the user, as the graphical image contacts marking 24. For example, one color graphical marking may cause the dot to move faster and another color may cause slower dot movement.

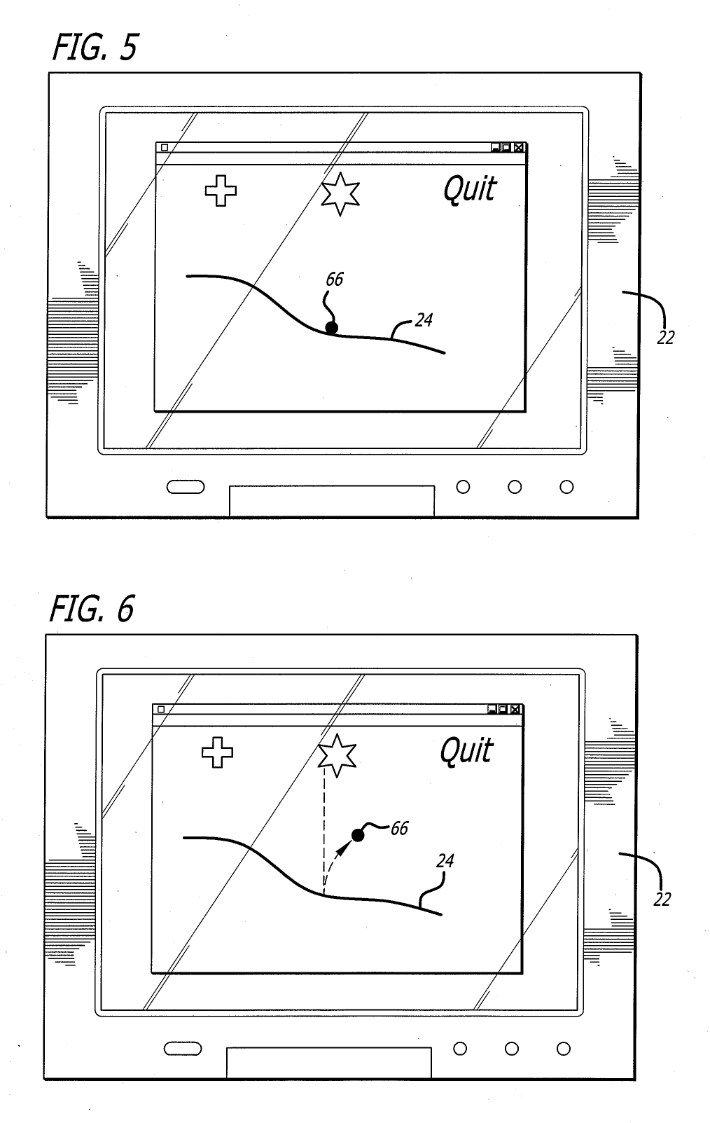

In step 70, the direction of dot movement changes when the dot contacts (“hits”) the location of marking 24 on the display as shown in FIG. 5. The color of the marking may define the dot's subsequent movement. For example, one color of marking 24 may cause the dot to bounce back in the opposite direction as shown in FIG. 6. A different color marking 24 could cause the dot to roll along marking 24 and roll off the edge of the marking.

The user can also influence the dot movement by placing, for example, the user's finger in the camera field of view. The dot movement will change when the dot coincides with the location of the finger. The dot may also be moved by moving the user's finger. The station performs a subroutine wherein the dot location on the image displayed by the monitor is compared with the marking or finger, etc. to determine an intersection of the dot and marking/finger. An orientation of the marking may also influence the dot. For example, if the marking is a line at an oblique angle, the dot may roll down the line. The movement of the dot may be based on a dot movement library stored in the system. Different inputs may invoke different software calls to the library to perform subroutines that cause the dot to move in a specified manner. A more detailed process description of the process is attached as an Appendix.

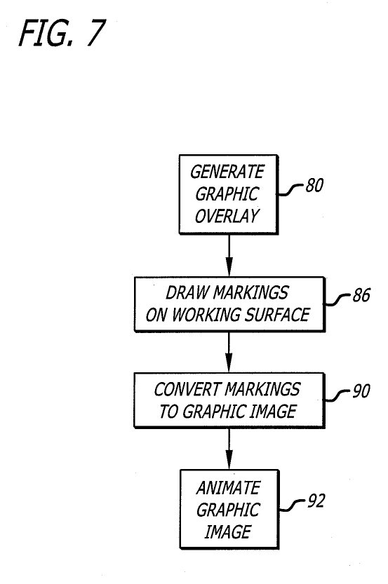

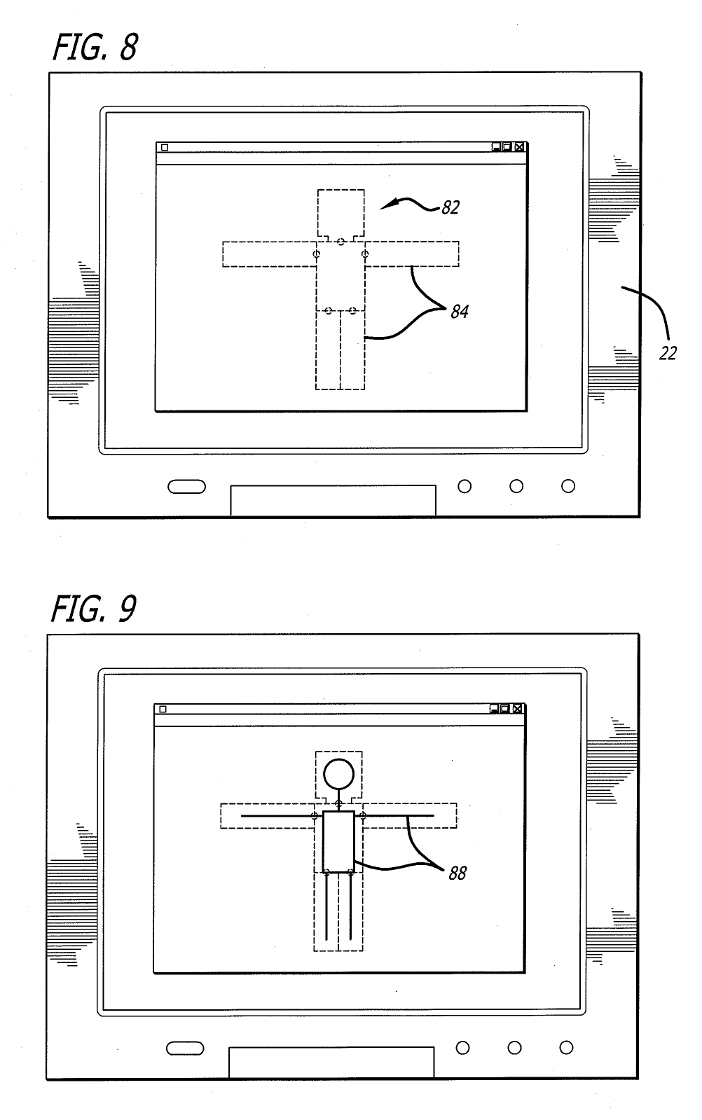

FIG. 7 shows a process of another use of the system. In step 80 a graphic template 82 as shown in FIG. 8 is overlayed onto the image of the working surface, to be displayed by the monitor after the image is captured by the camera 12. The template 82 could be displayed on the monitor, or could be a separate sheet, such as paper or acetate (transparent or non-transparent) placed by the user over the working surface 14. The template 82 may include a plurality of graphic blocks 84 as shown in FIG. 8. In step 86, the user can use the writing instruments to draw markings 88 within each block 84 as shown in FIG. 9. The markings 88 can collectively create a character. As shown in FIG. 7, once the markings are completed the user can provide an input that converts the markings to a graphical image displayed by the monitor and causes an animation of the character in steps 90 and 92, respectively. By way of example, the user may push the BACKSPACE key to cause animation of the character. A bitmap with RGB values for each pixel of the final image captured by the camera can be stored in memory and used to create the animated character displayed by the monitor. The animation may be generated with use of a library of animations for each block. For example, the process may identify the character as having arms and legs and move graphical arms and legs in a “flapping” manner based on an appendage flapping software subroutine. It should be noted that in the event template 82 is a separate physical element placed on the working surface 14 by the user, FIG. 7 would not require step 80.

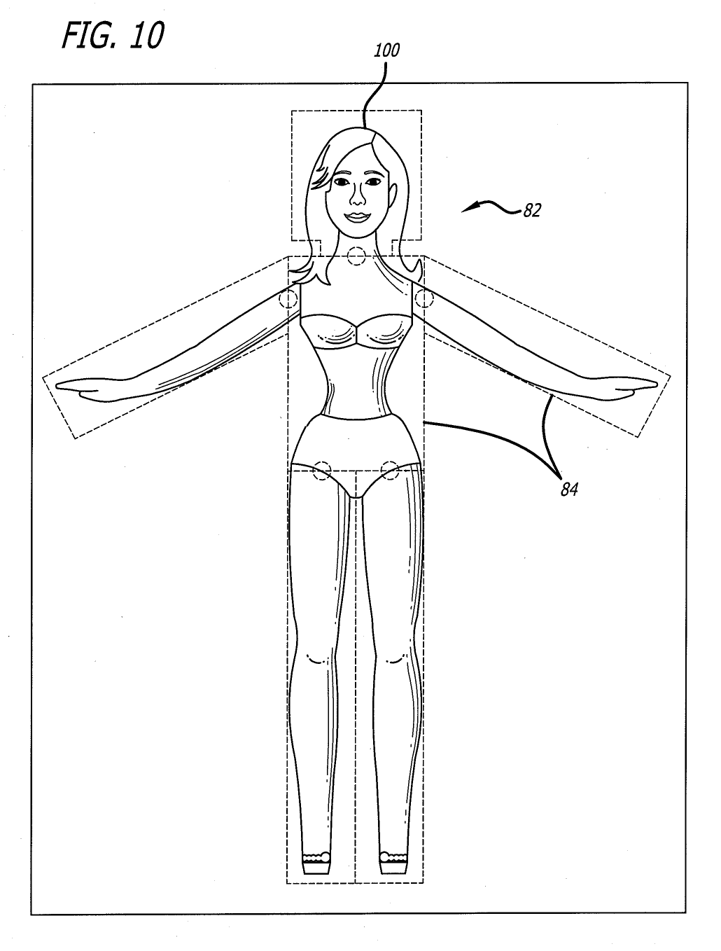

FIG. 10 shows the user input to be a picture of a character 100 on the working surface. The picture character can be aligned with the block 84 of the template 82 shown in FIGS. 8 and 10. The camera captures the picture and the captured picture image is stored in memory, for example as a bitmap that includes the RGB values for each pixel. The picture character is converted to a graphical image displayed by the monitor. The animation process can be invoked to animate the character as described in the process of FIG. 7. Alternatively the character 100 could be a three-dimensional element such as a small doll. The camera 12 could also be redirected off the working surface to capture an image of, for example, the actual user, in which case the image of the user could be animated in like manner.

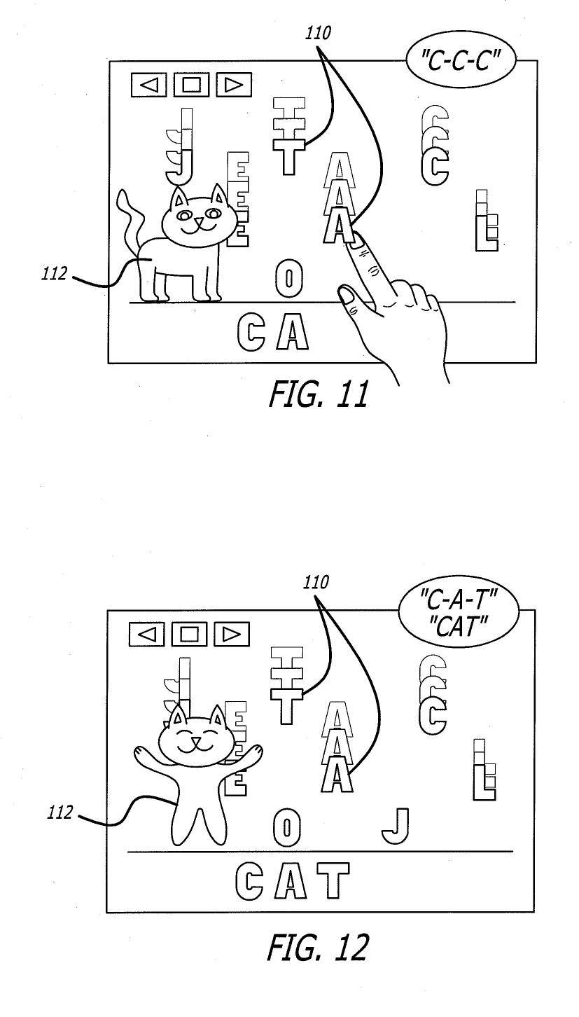

FIGS. 11 and 12 show an educational usage of the system. The image displayed by the monitor includes rows of letters 110 that scroll down the screen, and a character 112. Sounds associated with the letters may be also generated by the system. The user may move their finger into the view of the camera to select a letter 110. The letters can be selected to spell the character 112, for example, the correct spelling for CAT. If the user correctly picks out the letters the character 112 can become animated. Instead of using a finger, the user could employ colored styluses to select letters 110. Different colored styluses could generate unique letter actions, such as “magnetic” attachment to the stylus, “bounce-off” from the stylus, etc., in like manner as described in FIGS. 3 and 6.

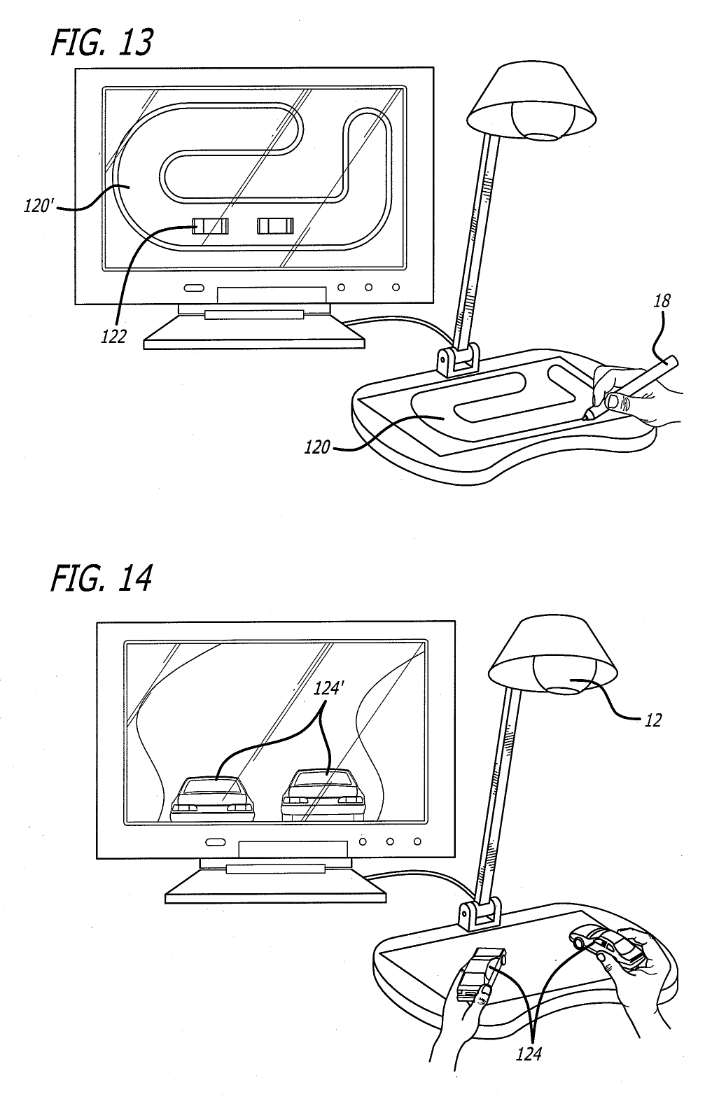

FIGS. 13 and 14 show other usages of the system. A track 120 may be placed on the working surface as shown in FIG. 13. The system may display a graphical version 120′ of the track 120 and graphical vehicles 122 that move around the track. Each user can mark the track with a color to vary a track characteristic. For example, a user-may mark a part of the track with a certain color to cause the graphical vehicle 122 to go faster at that track location. The system determines changes by looking at differences in the RGB bitmap. Each player may have a working surface 14 and camera 12 so that they can mark the other person's track without the other player seeing the marking. A player can created unknown variables such as speed for the other player. The description of a racetrack is exemplary. The theme could be a game with rolling balls, bombs, balloons, etc., with user-drawn elements affecting play action.

As shown in FIG. 14, each player may hold a toy vehicle 124 below the camera 12. Movement of the toy vehicles are captured by the camera 12 and analyzed by the station to create a corresponding movement of a graphical vehicle 124′ moving along a track. The corresponding movement can be performed by comparing the bitmap of the captured image with a bitmap of a previously captured image to determine any changes in RGB pixel values. The station changes the graphical vehicles 124 to correspond with the changes in the RGB pixel values. The cars 124 could each be of a unique color to provide identification for system library onscreen image display.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

For example, one of a plurality of tokens may be placed on the working surface, wherein each token has a different color. Each color will cause a different graphical image, or change in a graphical background setting, to be displayed on the station monitor. Likewise, a die with different colors on each surface may be tossed onto the working surface. Each color will cause a different graphical image, or a change in a graphical background setting, to be displayed on the station monitor.

What is claimed is:

1. An electronic system, comprising:
a working surface;
a camera that can capture at least one image on said working surface; and,
a control station that is coupled to said camera and includes a monitor that can display said captured image, said monitor displays a moving graphical image having a characteristic that is a function of a user input on said working surface that is captured by said camera.

2. The system of claim 1, wherein said user input is a marking on said working surface that varies the movement of said graphical image.

3. The system of claim 2, wherein said marking is one of a plurality of colors, each of said colors causes a different movement of said graphical image.

4. The system of claim 2, wherein an orientation of said marking causes movement of said graphical image in a certain direction.

5. The system of claim 3, wherein said different movement is a change of speed of said graphical image.

6. The system of claim 1, wherein said displayed graphical image is a character.

7. The system of claim 1, wherein said user input is created by at least one marking on said working surface.

8. The system of claim 1, wherein said user input is a picture placed on said working surface.

9. The system of claim 1, wherein said user input is a human appendage.

10. The system of claim 1, wherein said user input is an instrument that has a color.

11. The system of claim 1, wherein said monitor displays a grid.

12. The system of claim 1, wherein said image includes a three-dimensional object.

13. The system of claim 11, wherein said image includes a picture image.

14. The system of claim 11, wherein said image includes an object aligned with said grid.

15. The system of claim 11, wherein said grid is a graphic overlay.

16. The system of claim 11, wherein said grid is located on said working surface.

17. The system of claim 11, wherein said grid is located on a separate movable element positioned atop said working surface.

18. The system of claim 1, wherein said control station monitor displays a graphical icon and said graphical icon can be selected by placing a user input relative to said working surface so that said captured image includes said user input at a location that corresponds to a location of said graphical icon.

19. The system of claim 1, wherein said control station includes a computer.

20. An electronic system, comprising:
a working surface;
a camera that can capture at least one image on said working surface; and,
means for displaying said captured image and displaying a moving graphical image having a characteristic that is a function of a user input on said working surface that is captured by said camera.

21. The system of claim 20, wherein said user input is a marking on said working surface that varies the movement of said graphical image.

22. The system of claim 21, wherein said marking is one of a plurality of colors, each of said colors causes a different movement of said graphical image.

23. The system of claim 21, wherein an orientation of said marking causes movement of said graphical image in a certain direction.

24. The system of claim 22, wherein said different movement is a change of speed of said graphical image.

25. The system of claim 20, wherein said displayed graphical image is a character.

26. The system of claim 20, wherein said user input is created by at least one marking on said working surface.

27. The system of claim 20, wherein said user input is a picture placed on said working surface.

28. The system of claim 20, wherein said user input is a human appendage.

29. The system of claim 20 wherein said user input is an instrument that has a color.

30. The system of claim 20, wherein said monitor displays a grid.

31. The system of claim 20, wherein said image includes a three-dimensional object.

32. The system of claim 30, wherein said image includes a picture image.

33. The system of claim 30, wherein said image includes an object aligned with said grid.

34. The system of claim 30, wherein said grid is a graphic overlay.

35. The system of claim 30, wherein said grid is located on said working surface.

36. The system of claim 30, wherein said grid is located on a separate movable element positioned atop said working surface.

37. The system of claim 20, wherein said control station monitor displays a graphical icon and said graphical icon can be selected by placing a user input relative to said working surface so that said captured image includes said user input at a location that corresponds to a location of said graphical icon.

38. A method for varying a graphical image displayed on a monitor, comprising:
creating a user input on a working surface;
capturing an image of the user input with a camera; and,
displaying a moving graphical image having a characteristic that is a function of a user input on said working surface that is captured by said camera.

39. The method of claim 38, wherein the user input is a marking on said working surface that varies the movement of the graphical image.

40. The method of claim 38, wherein the marking is one of a plurality of colors, each of said colors causes a different movement of said graphical image.

41. The method of claim 40, wherein an orientation of the marking causes movement of the graphical image in a certain direction.

42. The method of claim 40, wherein the different movement is a change of speed of the graphical image.

43. The method of claim 38, wherein the displayed graphical image is a character.

44. The method of claim 38, wherein the user input is a picture placed on said working surface.

45. The method of claim 38, wherein the user input is a human appendage.

46. The method of claim 38, wherein said user input is an instrument that has a color.

47. The method of claim 38, further comprising displaying a grid.

48. The method of claim 47, wherein the image includes a three-dimensional object.

49. The method of claim 47, wherein the image includes a picture image.

50. The method of claim 47, wherein the image includes an object aligned with the grid.

51. The method of claim 47, wherein the grid is a graphic overlay.

52. The method of claim 47, wherein the grid is located on the working surface.

53. The method of claim 47, wherein the grid is located on a separate movable element positioned atop the working surface.

54. The method of claim 38, further comprising selecting a graphical icon that is displayed by placing a user input relative to the working surface so that the captured image includes the user input at a location that corresponds to a location of the graphical icon.
